(19) United States
(12) Patent Application Publication
(10) Pub. No.: US 2023/0314823 A1
(43) Pub. Date: Oct. 5, 2023

(54) METHODS AND SYSTEMS FOR GENERATING HIGH PEAK POWER LASER PULSES

(71) Applicant: IMAGINE OPTIC, Orsay (FR)

(72) Inventors: Guillaume Gorju, Dourdan (FR); Xavier Levecq, Gif-Sur-Yvette (FR); Adam Ayeb, Orsay (FR); Fahem Boudries, Massy (FR)

(73) Assignee: IMAGINE OPTIC, Orsay (FR)

(21) Appl. No.: 18/041,143

(22) PCT Filed: Aug. 6, 2021
(86) PCT No.: PCT/EP2021/072100

§ 371 Date: Mar. 13, 2023

(30) Foreign Application Priority Data
Aug. 14, 2020 (FR) FR2008512

(51) Int. Cl. G02B 27/09

(52) U.S. Cl. CPC G02B 27/0944; G02B 27/0927; G02B 27/0916

(57) ABSTRACT

The aim of the present description is a system for generating high peak power laser pulses including a light source for emitting initial nanosecond laser pulses, a fiber-based device for conveying laser pulses, including at least one first multimode fiber with a single core, a diffractive optical element and an optical system that generates, from each of said initial laser pulses, a laser pulse, the spatial intensity distribution of which on an input face of said first multimode fiber includes a “top hat” component summed with a speckle pattern. The system further includes a spatial shaping module that transforms a first electric field into a second electric field formed by a sum of N components that are at least partially spatially incoherent with one another, N≥2, such that the contrast of said speckle pattern is limited compared to an initial contrast defined without a spatial shaping module.

### TECHNICAL FIELD OF THE INVENTION

The present description relates to methods and systems for generating high peak power laser pulses particularly intended for laser shock. The present description is applicable, for example, in laser peening, laser shock spectroscopy, laser ultrasound generation or laser cleaning of components.

### PRIOR ART

Laser shock surface treatment applications, i.e., with plasma formation, require pulses with very high peak power, typically of approximately 10 megawatts (MW) or more, i.e., typically pulses with a duration of the order of a few tens of nanoseconds or less and that have energy levels of more than one hundred millijoules. These pulses, which are typically focused on areas of a few mm², allow energy densities to be achieved of the order of tens of Joules per square centimeter for forming laser shocks. These applications include, for example, laser shock spectroscopy, laser cleaning, laser ultrasound generation, for example, for analyzing the crystalline structure of a material and laser shock peening for improving the lifetime and the mechanical strength of parts.

Laser peening is described, for example, in patents U.S. Pat. No. 6,002,102 [Ref. 1] and EP 1528645 [Ref. 2]. A first thin absorbent layer is deposited onto the part to be treated. During operation, the high peak power laser pulses vaporize the absorbent layer, which generates a hot plasma. The expansion of the plasma leads to an intense compression wave that allows deep prestresses to be generated in the material of the part to be treated. A second layer, called confinement layer, that is transparent to radiation, for example, water or a material transparent to the length of the incident radiation, for example, quartz, helps the shock wave to expand toward the inside of the surface to be treated. This method, called laser peening, allows the mechanical strength of the parts to be increased to cyclic fatigue. This method is generally carried out by conveying the beam in free space up to the zone to be treated.

However, conveying high-power laser beams in free space generates safety problems and makes accessibility to confined or hostile locations (for example, submerged environments) very complex.

In order to access surfaces located in confined or hostile environments, optical fibers appear to be well suited tools. Nevertheless, some of the methods described above, such as laser peening or surface laser cleaning, are generally carried out in dusty industrial environments and the damage thresholds of the input and output surfaces of the fibers are significantly lower. Moreover, apart from the cleanliness aspects, for pulsed lasers with a pulse duration of less than 1 μs, the peak power level that can be injected into a fiber is limited by the dielectric damage threshold of the material forming the core of the fiber. Thus, for pulses from 10 ns to 1,064 nm, the damage threshold of the air-silica interface is approximately 1 GW/cm².

In order to limit the risks of damage during injection and during propagation, the use of waveguides with large core diameters is preferred. However, the large cores (typically greater than 1 mm) are not very flexible and excessively large bends create evanescent wave losses that can damage the fiber.

A set of optical fibers (or “bundle”) can be used, as described, for example, in patent U.S. Pat. No. 6,818,854 [Ref. 3]. However, in order to limit any losses during injection and during propagation in this type of component, it is preferable for the light energy to be injected into each fiber individually, which makes the injection complex and expensive; moreover, a high-aperture focusing optical system needs to be provided at the output of the component, which makes the optical system complex, expensive and bulky.

Therefore, a requirement exists for generating high peak power nanosecond pulses by means of a system with a fiber-based device comprising a fiber with a single core, and which allows the damage thresholds of the fibers to be increased and improves the flexibility of the fiber-based device in order to prevent its optical deterioration by mechanical stresses.

In patent application WO 2019/233899 [Ref. 4], the applicant particularly proposed a system for generating high peak power laser pulses comprising a light source for emitting nanosecond laser pulses, a fiber-based device for conveying laser pulses comprising a multimode fiber with a single core and an optical amplifier arranged at the output of the fiber-based device for optically amplifying the laser pulses. The system thus described allows very high peak powers to be available for the incident pulses on the material in which laser shocks are intended to be generated, while safeguarding the input and output interfaces of the fiber-based device. It allows a limited diameter multimode fiber to be used, that is typically below 1 mm, or even below 300 μm, which provides the fiber-based device with significant flexibility, and as a result easier access to confined environments.

In patent application WO 2019/233900 [Ref. 5], the applicant also proposed a module for temporally shaping laser pulses, arranged upstream of the fiber-based device, and configured to reduce the power spectral density (PSD) by reducing the temporal coherence of the first pulses. Reducing the PSD to quasi-constant energy or with a low energy reduction allows any overintensities attributed to “speckle” (also called “flicker”) to be limited, the injection into the fiber-based device to be safeguarded and the nonlinear effects to be limited. As in the previously described patent application [Ref. 4], it is then possible to use a small diameter multimode fiber.

The two patent applications [Ref. 4] and [Ref. 5] mentioned above also describe the possibility of spatially shaping the beam in order to evenly distribute the spatial power density of the pulses at the input of the fiber-based device. An even distribution of the spatial power density allows the overintensities in the fiber to be limited that are related to the Gaussian intensity distribution of a beam, for example. Thus, a module is described, for example, for spatially shaping the pulses, allowing pulses to be formed with square or “top hat” type spatial intensity distribution, i.e., with spatial variation of the low intensity that is typically limited to +/−10%. Top hat type spatial shaping also allows the light beam formed by said first pulses to be adapted to the dimension of the core of the multimode fiber.

Such a spatial shaping module can comprise a diffractive optical element (or “DOE”) associated with an optical system, for example, an optical lens, for carrying out spatial shaping adapted to the size and the geometry of the multimode optical fiber intended for conveying nanosecond pulses. In practice, spatially shaping the beam in a Fourier plane (for example, the image focal plane) of the optical system corresponds to the spatial Fourier transform of the phase mask stipulated by the DOE convoluted with the spatial Fourier transform of the spatial intensity distribution of the beam on the DOE. Thus, the phase mask stipulated by the DOE can be computed such that the result of this convolution forms a given intensity distribution on the input face of the fiber, for example, a “top hat” type intensity distribution, with the diameter of the beam on the input face of the fiber being proportional to the focal length of the optical system. The DOE associated with an optical lens type optical system is therefore particularly advantageous for spatially shaping nanosecond pulses within the context of conveying high peak power pulses since, by selecting the parameters of the DOE, a laser beam, independently of its spatial distribution at the source output, can be injected into a single-core fiber while complying with the size of the waveguide and its numerical aperture.

However, the applicant has highlighted the appearance of overintensities or “hot spots” associated with the presence of a DOE, with said overintensities or “hot spots” being able to induce local damage of the input surface of the fiber due to an excessively high local light density. The applicant has particularly demonstrated that the most intense hot spots can have a peak power that is up to 6 times greater than the average power of a pulse injected into the fiber.

By way of an example, FIG. 1 illustrates a spatial shaping module with a diffractive optical element 20 cooperating with an optical system 21, for example, an optical lens, in order to carry out spatial shaping adapted to the size and to the geometry of a multimode optical fiber 10 intended for conveying nanosecond pulses. The multimode optical fiber 10 comprises a cladding 11 and a multimode core 12. The curve 31 represents a profile of the spatial intensity distribution of a beam formed by said nanosecond pulses. The spatial intensity distribution profile is measured in an input plane of the multimode optical fiber 10, by means of a detector (not shown), in arbitrary units (a.u.), along an axis of measurement of a detection surface of the detector passing through the center of the beam. On the abscissa, the distance represents a number of pixels (or elementary detectors) of the detection surface, along the measurement axis, from an arbitrary point, reference “0”, located outside the beam. The image 32 shows the intensity distribution of the beam in the input plane of the multimode optical fiber 10. As can be seen on the curve 31 or on the image 32, overintensities are apparent that are capable of damaging the fiber 10. The applicant has demonstrated that the overintensities result from speckle type interference.

An aim of the present description is a method and a system for generating high peak power pulses (typically of approximately 10 MW or above), allowing safer injection into a single-core fiber-based device, and ensuring safe propagation over long distances, while making the use of flexible fibers possible.

### SUMMARY OF THE INVENTION

In the present description, the term “comprise” means the same as “include” or “contain”, and is inclusive or open and does not exclude other elements that are not described or shown.

Furthermore, in the present description, the term “approximately” or “substantially” is synonymous (means the same as) with a margin that is less than and/or greater than 10%, for example, 5%, of the respective value.

According to a first aspect, the present description relates to a system for generating high peak power laser pulses comprising:
a light source for emitting initial nanosecond laser pulses;
a fiber-based device for conveying laser pulses, comprising at least one first multimode fiber with a single core;
a diffractive optical element and an optical system both arranged upstream of the fiber-based device, and configured to generate, from each of said initial laser pulses, a laser pulse at the input of the fiber-based device, wherein the spatial intensity distribution of each of said laser pulses on an input face of said first multimode fiber comprises a low spatial frequency “top hat” type component summed with a high spatial frequency component resulting from speckle type interference;
a spatial shaping module, arranged upstream of the fiber-based device, configured to transform a first electric field into a second electric field formed by a sum of N components that are at least partially spatially incoherent with one another, N≥2, such that the contrast of the high spatial frequency component resulting from speckle type interference is limited compared to an initial contrast defined without the spatial shaping module.

According to the present description, the input face of the multimode fiber is substantially coincident with a Fourier plane of said optical system.

The Fourier plane is a plane where a Fourier transform of the electric field is formed and corresponds, for example, in the case of a collimated beam, to an image focal plane of a lens or of a mirror.

According to one or more embodiments, the optical system comprises one or more lenses configured to form a converging optical system and/or one or more reflective optical elements, for example, a converging spherical mirror or an off-axis parabolic mirror. In general, the optical system can comprise one or more optical elements allowing light to be focused in order to generate a Fourier plane.

It should be noted that the DOE can be produced on a face of one of the optical elements of the optical system, for example, etched on a concave (or parabolic) mirror forming said optical system.

A square or “top hat” type spatial intensity distribution according to the present description is a substantially uniform spatial intensity distribution, with a spatial variation of the low intensity that is typically limited to +/−10%.

The applicant has demonstrated that such a system, by virtue of the shaping module, allowed the contrast of the high-frequency component resulting from speckle type interference to be reduced, by virtue of the reduction of the spatial coherence of the pulses thus shaped.

According to one or more embodiments, said spatial shaping module is arranged upstream of said optical system. This arrangement allows the spatial shaping module to receive a laser beam formed by said substantially collimated pulses. However, the spatial shaping module can be arranged downstream or upstream the DOE.

According to one or more embodiments, said spatial shaping module comprises a polarization scrambler, configured to transform a first electric field into a second electric field formed by a sum of two components along two orthogonal axes, with the two components having a variable phase shift along a given axis.

According to one or more embodiments, the variable phase shift along said axis is periodic, resulting in a periodic variation of the polarization state of the electric field at the output of the polarization scrambler, and the polarization scrambler is arranged such that a spatial intensity distribution of said first electric field comprises, along said axis, a dimension that is greater than a variation period of the polarization state.

According to one or more embodiments, the light source is a longitudinal multimode source and said spatial shaping module comprises at least one first diffraction grating, configured to transform a first electric field into a second electric field formed by a sum of N components, N≥2, wherein said N components are characterized by non-collinear wave vectors.

According to one or more embodiments, N is comprised between 2 and 10.

According to one or more embodiments, said spatial shaping module comprises at least one second grating arranged downstream said first grating.

According to one or more embodiments, said spatial shaping module further comprises a polarization scrambler, with said at least one first grating being arranged upstream the polarization scrambler.

According to a second aspect, the present description relates to a method for generating high peak power laser pulses comprising:
emitting initial nanosecond laser pulses by means of a light source;
generating, by means of a diffractive optical element and an optical system, from each of said initial laser pulses, a laser pulse, wherein the spatial intensity distribution of each of said laser pulses in a Fourier plane of the optical system comprising a low spatial frequency “top hat” type component summed with a high frequency component resulting from speckle type interference;
conveying said laser pulses by means of a fiber-based device comprising a multimode fiber with a single core, wherein an input face of the multimode fiber is substantially coincident with said Fourier plane of the optical system;
spatially shaping said initial laser pulses by means of a spatial shaping module, arranged upstream of the fiber-based device, and configured to transform a first electric field into a second electric field formed by a sum of a plurality of N components, N≥2, with said N components being at least partially spatially incoherent with one another, such that the contrast of said high spatial frequency component resulting from the speckle type interference on the input face of said first multimode fiber is limited compared to an initial contrast defined without the spatial shaping module.

### BRIEF DESCRIPTION OF THE FIGURES

Further advantages and features of the invention will become apparent upon reading the description, which is illustrated by the following figures:

FIG. 1, already described, shows a simplified diagram illustrating elements of a system for generating high peak power laser pulses according to the prior art;

FIG. 2 shows a simplified diagram illustrating a system for generating high peak power laser pulses according to the present description;

FIG. 3 shows a simplified diagram illustrating a polarization scrambler adapted for spatially shaping pulses in a system according to the present description and the effects of such a polarization scrambler;

FIG. 4 shows a simplified diagram illustrating elements of a system for generating high peak power laser pulses according to the present description with a spatial shaping module comprising a polarization scrambler, as described, for example, with reference to FIG. 3;

FIG. 5A shows a simplified diagram illustrating a spatial shaping module with a first grating, for spatially shaping pulses in a system according to the present description, and the effects of such a spatial shaping module;

FIG. 5B shows a simplified diagram illustrating a spatial shaping module with a first grating and a second grating, for spatially shaping pulses in a system according to the present description, and the effects of such a spatial shaping module;

FIG. 6 shows a simplified diagram illustrating elements of a system for generating high peak power laser pulses according to the present description with a spatial shaping module comprising a grating, as described, for example, with reference to FIG. 5A;

FIG. 7 shows a simplified diagram illustrating elements of a system for generating high peak power laser pulses according to the present description with a spatial shaping module comprising a polarization scrambler as described, for example, with reference to FIG. 3, and a grating, as described, for example, with reference to FIG. 5A.

### DETAILED DESCRIPTION OF THE INVENTION

Throughout the figures, the elements are not shown to scale for better visibility.

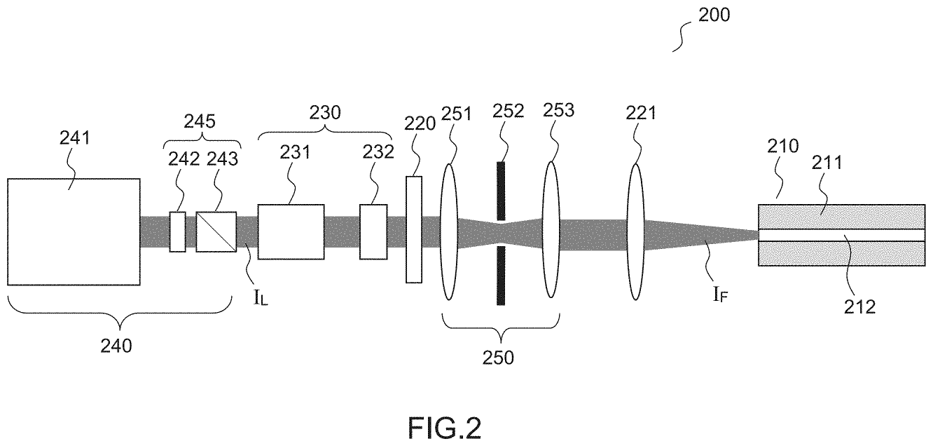

FIG. 2 shows a simplified diagram illustrating a system 200 for generating high peak power laser pulses according to the present description.

The system 200 comprises a light source 240 for emitting initial nanosecond laser pulses I_{L} and a fiber-based device for conveying the laser pulses, comprising at least one first multimode fiber 210 with a single core 212 and a cladding 211.

In this example, the light source 240 comprises a laser source 241, for example, a Q-switched Nd:YAG type laser for emitting nanosecond pulses. The laser can be equipped with a frequency doubler module in order to emit at a wavelength of 532 nm. More generally, the laser source is, for example, an active or passive Q-switched solid-state laser for emitting high peak power nanosecond pulses (greater than 10 MW). This can be, for example, a Yb:YAG or even titanium sapphire laser depending on the wavelength that is intended to be used. The laser source s naturally polarized, with the polarization being able to be linear, circular or elliptical.

The light source 240 can (optionally) contain an attenuator 245 for the emission optical power, comprising, for example, a half-wave plate followed by one or more polarization filters (Brewster plate, Glan prism or Glan-Thomson prism, for example).

The system 200 further comprises a diffractive optical element (DOE) 220 and an optical system 221, with the elements 220 and 221 being arranged upstream of the fiber-based device, and being configured to generate, on an input face of said first multimode fiber 210, from each initial laser pulse, a laser pulse at the fiber input I_{F} defined by an electric field comprising a “top hat” type spatial intensity distribution. The system 200 comprises, for example, a spatial shaping module 230 that will be described in further detail hereafter and, in this example, a filtering device 250. The filtering device 250 comprises, for example, a set of lenses 251, 253 configured to form an intermediate focal plane, in which a diaphragm 252 is arranged. Such a filtering device is configured to eliminate unwanted diffraction orders from the DOE (typically of the order 0 and all orders greater than or equal to 2).

At the output of the light source 240, each initial nanosecond laser pulse I_{L} is defined by an initial electric field with a pulse ω₀. In the case of a field propagating in a direction z and that is linearly polarized, for example, according to a vector \vec{e₁}, the field of an initial laser pulse I_{L} is written as:

\vec{E}(x,y,z,t)=E₀(x,y,t)e^{j(ω}^{₀}^{t-k,z)}·\vec{e₁} [Math 1]

The field at the output of the laser has spatial coherence that can be qualified by a degree of coherence. The degree of spatial coherence of the radiation between two points (x₁, y₁) and (x₂, y₂) located in a plane perpendicular to the propagation direction z is expressed as follows:

$$γ ( {x}_{2} - {x}_{1} , {y}_{2} - {y}_{1} ) = \frac{〈 \vec{E} ( {x}_{1} , {y}_{1} , z , t ) \cdot \vec{E} * ( {x}_{2} , {y}_{2} , z , t ) 〉}{\sqrt{〈 {\vert \vec{E} ( {x}_{1} , {y}_{1} , z , t ) \vert}^{2} 〉 〈 {\vert \vec{E} ( {x}_{2} {y}_{2} , z , t ) \vert}^{2} 〉}} \qquad [ Math 2 ]$$

Thus, radiation is totally spatially coherent when the degree of coherence reaches the unit value for any pair of points. Conversely, the spatial coherence tends toward 0 when the degree of coherence is low, for all pairs of points. One means for experimentally observing the degree of coherence of a source involves measuring the contrast of an interference pattern (Young's slits or speckle pattern type). The more spatially coherent the incident radiation, the greater the contrast of the interference pattern.

In practice, when a DOE is used in a pulse generation system according to the present description, the applicant has demonstrated that the coherence of the incident radiation resulted in a high contrast of the high-frequency component resulting from speckle type interference.

The DOE 220 comprises, for example, in a known manner, in the case of a transmission component, a plate of a material, for example, of silica, etched into the thickness in order to generate a spatially variable phase shift of the incident electric field in order to obtain, in a Fourier plane coincident with an input plane of the multimode fiber 210, i.e., in this example, in a focal plane of the optical system 221, an electric field with a desired amplitude.

The optical system 221 can comprise one or more lenses configured to form a converging optical system and/or one or more reflecting optical elements, for example, a converging spherical mirror or an off-axis parabolic mirror. In general, the optical system 221 can comprise one or more optical elements allowing light to be focused in order to generate a Fourier plane.

Although shown as two separate elements in FIG. 2, the DOE 220 also can be directly etched onto one of the optical elements forming the optical system 221.

Even though FIG. 2 shows the DOE 220 so as to be operating for transmission, the mounting can be adapted for operating the DOE for reflection. If t(x, y) denotes the phase transmission coefficient of the DOE, the electric field transmitted immediately after the DOE is written as:

\vec{E}ₜ(x,y,z,t)=E₀(x,y,t)e^{j(ω}^{₀}^{t-k,z)}·t(x,y)·\vec{e₁} [Math 3]

In the Fourier plane, the electric field is provided by:

\vec{E}ₒᵤₜ(u,v)α [symbol] (u,v,t)⊗\tilde{T}(u,v)·\vec{e₁}=S(u,v)·\vec{e₁} [Math 4]

Where

$$u = \frac{x}{λ f} , v = \frac{y}{λ f}$$

are the coordinates in the Fourier space of the lens. The functions [symbol] (u, v) and \tilde{T}(u, v) represent the spatial Fourier transforms in the focal plane of the lens of E₀(x, y, t) and t(x, y).

If the field has a very high degree of spatial coherence, which is the case, for example, of TEM00 Gaussian laser pulses, the light intensity of the pulses in the Fourier plane is written as:

Iₒᵤₜ(u,v)α|S(u,v)|² [Math 5]

It should be noted that if the field is incident on the DOE with a wave vector \vec{k′} forming an angle θ₀ with the optical axis (z), the intensity pattern will be spatially offset from the optical axis by a distance u₀, with u₀=f·tan(θ₀).

In the preceding equations, however, it has been assumed that the DOE is “perfect”, i.e., without roughness. In practice, the method for manufacturing the DOE results in random roughness of the surface of the DOE, which is expressed on the transmission of the DOE by a random phase term e^{jφ}^{_{diff}}^{(x,y)}. Thus, it can be seen that the field shaped in the Fourier plane of the lens is expressed by:

\vec{Eₒᵤₜ}(u,v)α\tilde{E}₀(u,v,t)⊗\tilde{T}(u,v)\vec{e₁}+∫E₀(x,y,t)·e^{jφ}^{_{diff}}^{(x,y)}·e^{-j2π(xu+yv)}·dxdy·\vec{e₁} [Math 6]

The field is thus made up of a deterministic part allowing the desired shaping to be achieved and of a random part attributed to the roughness of the DOE. The electric field thus can be written in the Fourier plane in the form of a sum of two contributions:

\vec{Eₒᵤₜ}(u,v)=S(u,v)\vec{e₁}+E_{rand}(u,v)\vec{e₁} [Math 7]

With

E_{rand}=∫E₀(x,y,t)·e^{jφ}^{_{diff}}^{(x,y)}·e^{-j2π(xu+yv)}·dxdy

E_{rand} thus represents a random phase term in the Fourier plane of the lens due to the roughness of the DOE.

The two contributions of the field interfere with each other, which provides the “speckled” nature of the intensity of the pulses in the Fourier plane.

More specifically, the light intensity of the pulses in the Fourier plane is written as:

Iₒᵤₜ(u,v)=|S(u,v)|²+E_{rand}²+2E_{rand}S(u,v)cos (φ_{diff}) [Math 8]

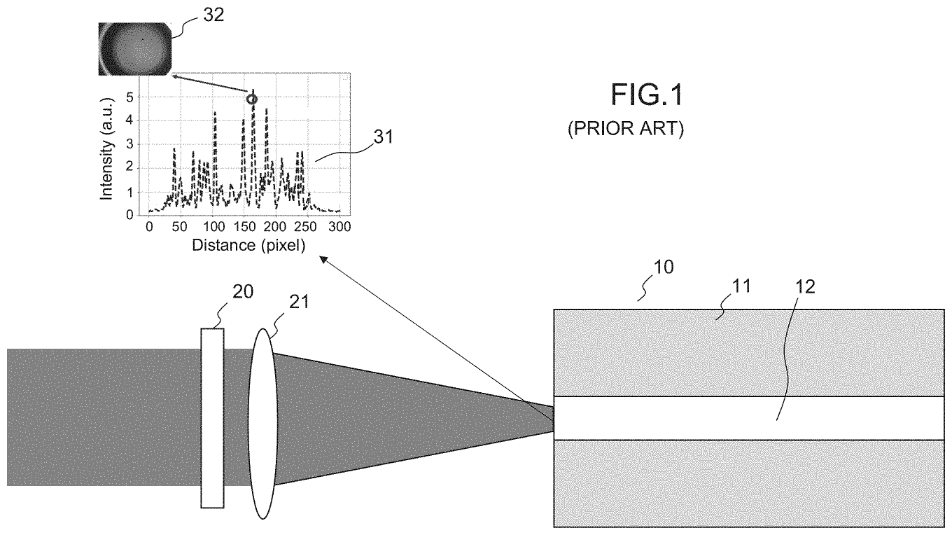

Therefore, the light intensity comprises a first low spatial frequency term of the top hat type and a random phase high spatial frequency term, which affects the shaping of the pulses in the input plane of the multimode fiber. This results in a diffraction pattern Iₒᵤₜ (u, v) made up of “grains” of random intensity (“speckle”), as illustrated in diagram 31 (FIG. 1).

The spatial shaping module 230 of the system 200 aims to reduce the contrast of the high-frequency component resulting from speckle-type interference on the input face of said first multimode fiber.

The contrast of the diffraction pattern Iₒᵤₜ (u, v) can be expressed as:

$$C = \frac{{σ}_{I}}{〈 I 〉} \qquad [ Math 9 ]$$

Where [symbol] I [symbol] is the average of the light intensity of the “top hat” and σ_{I} is the standard deviation.

The applicant has shown that the selection of a spatial shaping module 230, arranged upstream of the fiber-based device, and configured to transform a first electric field into a second electric field formed h a sum of a plurality N of components, which are at least partially spatially incoherent with one another, allowed the contrast of the high-frequency component resulting from speckle-type interference at the input of the multimode fiber to be reduced and, for this reason, allowed the injection of high peak power pulses into the multimode fiber to be safeguarded.

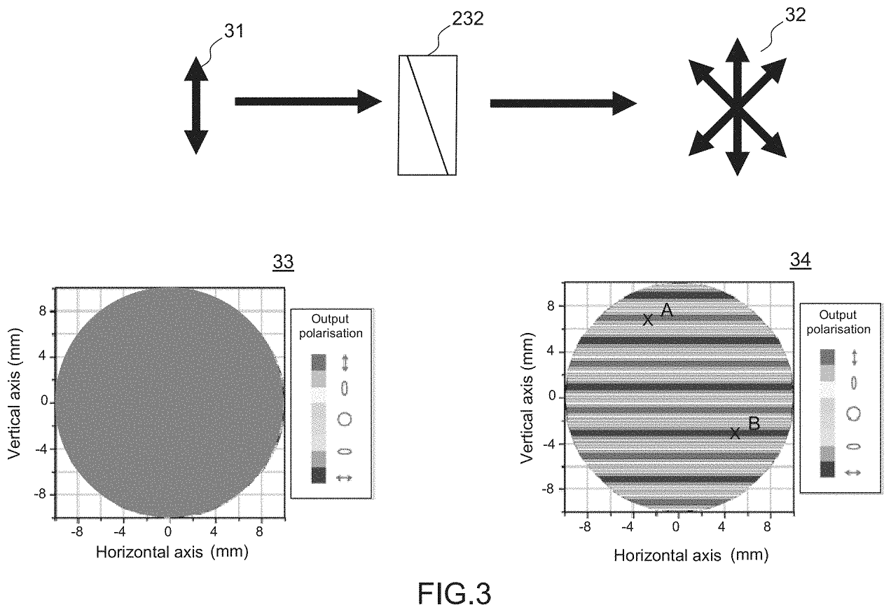

FIG. 3 shows a simplified diagram illustrating a polarization scrambler 232 configured for spatially shaping pulses in a system according to the present description and the effects of such a polarization scrambler. The polarization scrambler is, for example, a Cornu depolarizer (or quartz depolarizer), a liquid crystal depolarizer or a double prism depolarizer.

A first polarized electric field is considered, with linear, circular or elliptical polarization at the output of the laser 241. Throughout the remainder of the description, the effect of the depolarizer, or polarization scrambler, is explained in the case of a linear polarization, illustrated by the double arrow 31 in FIG. 3, but the effects are identical independently of the initial polarization of the pulses at the laser output. The polarization state at the output of the depolarizer is symbolized by the arrows 32, FIG. 3. Moreover, hereafter the depolarizer is assumed to be a Cornu (or quartz) depolarizer, but similar effects could be shown with other types of depolarizer.

The polarized electric field is written according to the above equation [MATH 1]. A Cornu depolarizer includes two prisms having an angle of 45° C. The prisms are made of quartz and are brought into contact in order to form a cube. Since the quartz is a birefringent crystal, the prisms are arranged so that their fast index axis is oriented at 90°. Thus, each prism acts as a phase plate. Since the thickness of the material through which the light passes varies spatially, the phase shift of the beam varies spatially. The phase shift is provided by the formula:

$$δ ( y ) = \frac{2 π}{λ} ( {n}_{1} - {n}_{2} ) [ 2 y - a ] \qquad [ Math 10 ]$$

Where n₂ and n₁ are respectively the extraordinary and ordinary index of quartz, a is the length over which the two prisms are in contact and d is the length of the depolarizer. At the output of the depolarizer, spatial shaping of the electric field in the plane (x, y) perpendicular to the propagation axis (z) of the beam was undertaken. The electric field at the output of the depolarizer is written as:

$$\vec{E} ( x , y , z , t ) = {E}_{0} ( x , y , t ) \frac{{e}^{j ( {ω}_{0} t - kz )}}{\sqrt{2}} ( \vec{{e}_{1}} + \vec{{e}_{2}} {e}^{- j \frac{2 π}{λ} ( ( {n}_{1} - {n}_{2} ) [ 2 y - a ] )} ) \qquad [ Math 11 ]$$

Thus, when the incident beam has a uniform linear polarization, at the output of the component, the beam will have a periodic polarization in the y direction. More specifically, each spatial coordinate of the beam has a different polarization state. In the above assumption, along the y-axis the beam will successively exhibit linear, circular and elliptical polarization states with different orientations.

The variation of the polarization state will be periodic along the y-axis. The variation period of the polarization is expressed as:

$$Δ y = \frac{λ}{2 ( {n}_{2} - {n}_{1} )} + \frac{a}{2} \qquad [ Math 12 ]$$

Thus, in order to have effective depolarization, the dimension of the incident beam advantageously will be, along the y-axis, greater than the variation period of the polarization state at the depolarizer output.

For a quartz depolarizer by Thorlabs®, for example, the spatial variation period of the polarization is 4 mm for a wavelength of 635 nm. In practice, the intention is for the dimension of the incident beam on the depolarizer to be at least equal to the polarization variation period, advantageously at least equal to twice the polarization period, in order to achieve effective depolarization and consequently a degree of polarization that tends toward zero.

A view of the effect of a depolarizer on the spatial shaping of the incident pulses is illustrated in diagrams 33, 34 of FIG. 3.

Diagram 33 shows the polarization state at the input of the polarizer, in this example a uniform polarization (linear polarization).

Diagram 34 shows the polarization state at the output of the polarizer. A variable polarization can be seen according to the spatial coordinates (x, y) of the considered beam. By considering two points A, B of coordinates (x₁, y₁) and (x₂, y₂), respectively, a drop can be seen in the degree of normalized spatial coherence as defined by the above equation [MATH 2].

In this example, the points A and B are orthogonally polarized, thus the degree of coherence drops to 0 because the numerator corresponding to the scalar product of the fields in (x₁, y₁) and (x₂, y₂) is zero. Therefore, it can be concluded that spatially depolarizing the initial pulses induces a reduction in the degree of coherence and, as a result, will cause a reduction in the contrast of the speckle pattern. When the degree of polarization (DOP) of the beam tends toward 0, the beam is considered to be completely depolarized, and the electric field at the output of the depolarizes can be written as the sum of two orthogonally polarized, and therefore spatially incoherent, contributions.

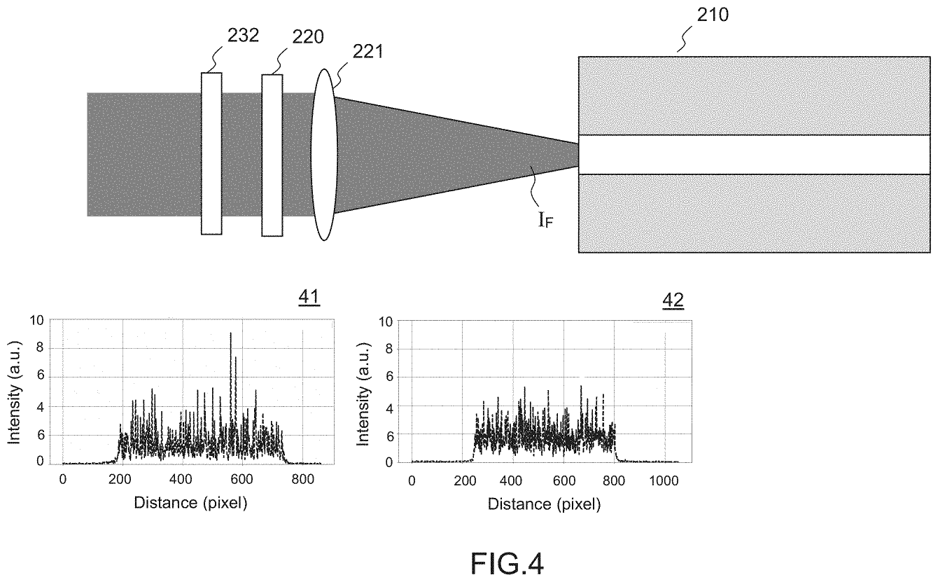

FIG. 4 thus shows a simplified diagram illustrating elements of a system for generating high peak power laser pulses according to the present description with a spatial shaping module comprising a polarization scrambler 232, as described, for example, with reference to FIG. 3.

The applicant has demonstrated that if the incident electric field on the DOE 220 is at least partially depolarized, this will have the effect of reducing the speckle contrast. In particular, as previously seen, a completely spatially depolarized field can be divided into two orthogonal polarization states that cannot interfere with one another. Each of the polarization states will generate a speckle pattern that is not spatially correlated with the other polarization state.

More specifically, in the case of an incident light made up of two independent (orthogonal) polarization states, the field of the pulses I_{F} in the Fourier plane of the optical system 221 used for shaping can be written as:

$${\vec{E}}_{Out} ( u , v ) α [ {E}_{0} ( x , y , t ) \int ( t ( x , y ) + {e}^{j {φ}_{diff} ( x , y )} ) \cdot {e}^{- j 2 π ( x u + y v )} d x d y ] ( \frac{1}{\sqrt{2}} \vec{{e}_{1}} + \frac{1}{\sqrt{2}} \vec{{e}_{2}} ) \qquad [ Math 13 ]$$

That is,

$${\vec{E}}_{Out} ( u , v ) α \frac{1}{\sqrt{2}} [ S ( u , v ) + {E}_{rand} ( {φ}_{a 1} ) ] \vec{{e}_{1}} + \frac{1}{\sqrt{2}} [ S ( u , v ) + {E}_{rand} ( {φ}_{a 2} ) ] \vec{{e}_{2}} \qquad [ Math 14 ]$$

The light intensity in the input plane of the multimode fiber 210 (FIG. 4) is then written as:

Iₒᵤₜ(u,v)α|S(u,v)|²+E_{rand}²+E_{rand}Eₒᵤₜ cos (φₐ₁)+E_{rand}Eₒᵤₜ cos (φₐ₂) [Math 15]

It can be seen from the above equation that the intensity profile is made up of the superposition of two independent random signals. Each of these random signals has a standard deviation of

$$\frac{{σ}_{I}}{2} ,$$

where σ_{I} is the standard deviation of the intensity distribution without a shaping module. Thus, the intensity distribution will have a standard deviation corresponding to the root mean square of the standard deviations of the two independent signals, equal to

$$\frac{{σ}_{I}}{\sqrt{2}} .$$

This results in a reduction in the speckle contrast by a factor of \sqrt{2}.

Thus, in FIG. 4, the top hat intensity profile at the input of the multimode fiber can be seen (diagram 42). In this example, the speckle contrast is reduced by a factor of \sqrt{2}relative to the speckle contrast without shaping (diagram 41, FIG. 4).

The above computations show that spatially shaping the polarization state of a laser allows the degree of spatial coherence of the radiation to be reduced. When the radiation is equivalent to two orthogonal polarization states, the contrast of the speckle pattern can be reduced by a factor of \sqrt{2}. Of course, in the case of less effective depolarization, the speckle contrast will be reduced, but by a lower factor. The above computations were carried out with a Cornu depolarizer. Of course, a demonstration of the depolarization on the contrast of the speckle would be the same with other types of depolarizer.

For example, a liquid crystal depolarizer can be configured to have a phase shift with an expression similar to that originating from a depolarizer of the Cornu type. Such liquid crystal depolarizers are described, for example, in U.S. Pat. No. 9,599,834 [Ref. 6] and comprise a thin film of liquid crystal polymer sandwiched, for example, between two glass plates, for example, N-BK7.

The double prism depolarizer (respectively made up of quartz and silica) is similar to the Cornu depolarizer; however, the angle between the two prisms is much smaller (typically 2°) and only the first prism is birefringent. The second prism is made of fused silica, which has a refractive index that is very similar to quartz. The fast axis of the quartz prism is generally at 45° to the corner. The entire component is more compact than a Cornu depolarizer (for the same aperture). At the output of the component, the polarization is periodic. As the angle of the prisms is much smaller than in a Cornu depolarizer, the spatial depolarization period is greater.

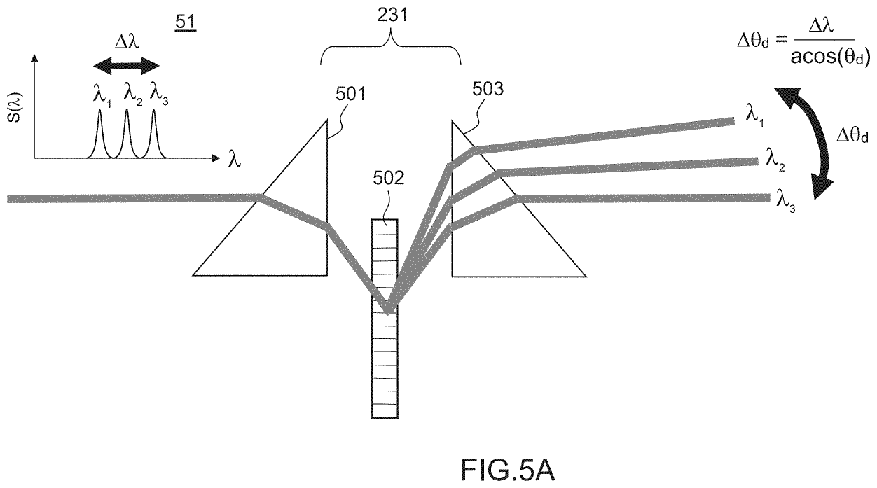

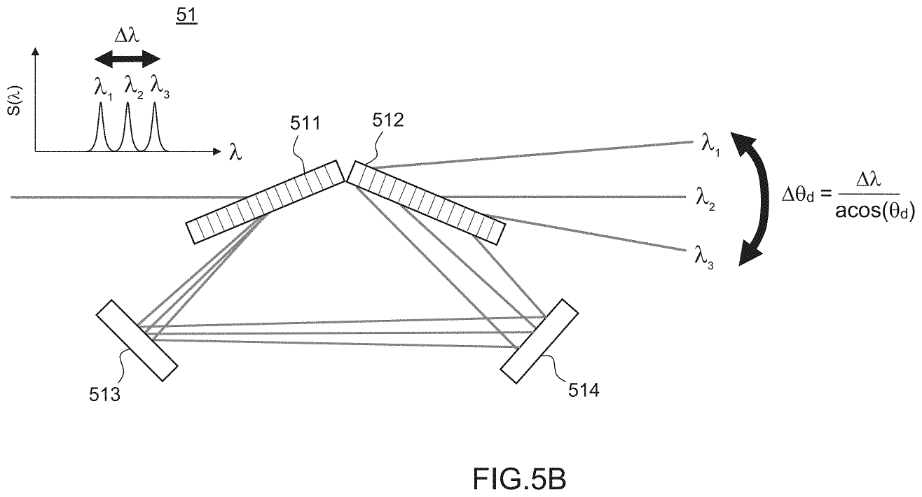

FIG. 5A shows a simplified diagram illustrating another example of a spatial shaping module for spatially shaping pulses in a system according to the present description. In this example, the spatial shaping module 231 comprises a dispersive element 502, for example, a grating. As illustrated in FIG. 5A, in this example the grating is arranged between two prisms 501, 503 (which could be replaced by minors); the prisms are configured to deflect the incident beams so that they reach the grating with a desired incidence angle, for example, an incidence angle for maximizing the diffraction effectiveness of the grating.

A grating spatial shaping module as described in FIG. 5A allows initial laser pulses to be shaped for which the electric field includes a plurality of spectral lines. To this end, the laser source 241 is a longitudinal multimode laser source, for example, a non-injected Q-switched type Nd:YAG laser.

As illustrated in FIG. 5A, the grating allows the N spectral lines of the laser to be spatially decorrelated. Thus, the use of a diffraction grating allows the contrast of the speckle present when shaping a laser beam to be reduced by means of a diffractive optical element.

More specifically, in order to demonstrate the effect of such a spatial shaping module, an incident planar longitudinal multimode electromagnetic wave is considered hereafter on a diffraction grating with a pitch α. The wave is expressed as:

$$\vec{E} ( x , y , z , t ) = \frac{{E}_{0} ( x , y , t )}{\sqrt{N}} ( {\sum }_{0}^{N} {e}^{j [ ( {ω}_{0} + n Δ ω ) t - k \cdot z + {ϕ}_{n} ]} + c c ) \vec{{e}_{1}} \qquad [ Math 16 ]$$

The parameter

$$Δω = 2 π \frac{c}{2 L} ,$$

is connected to the free spectral range of the laser cavity that is used. ϕₙ is a random phase term associated with each of the spectral components.

The incident wave on the grating 502 (FIG. 5A) is diffracted along a diffraction an of the grating and is provided by the following law:

$$sin ( {θ}_{d} ) = m \frac{λ}{a} + sin ( {θ}_{0} ) \qquad [ Math 17 ]$$

Where θ_{d}, θ₀, and m are the diffraction angle by the grating, the angle of incidence, and the diffraction order of the grating, respectively. In the case, for example, of a grating optimized according to the order −1 to Littrow (θ₀=−θ_{d}), the diffraction angle is provided by

$$sin ( {θ}_{d} ) = \frac{λ}{2 a} .$$

The diffraction angle depends on the illumination wavelength and therefore on the spectrum of the laser that is used. If the laser emits a multitude of spectral lines centered around a wavelength λ₀, the angular dispersion induced by the grating is provided by:

$$Δ {θ}_{d} = \frac{Δ λ}{a \cdot cos ( {θ}_{d} )} \qquad [ Math 18 ]$$

If the laser emits several lines separated by a free spectral interval,hen each line of the laser will be diffracted by the grating with an angle:

$${θ}_{n} = {θ}_{d} + n \frac{c \cdot Δ υ}{{υ}_{0}^{2} \cdot a \cdot cos ( {θ}_{d} )} = {θ}_{d} + n \cdot {Δθ}_{d} \qquad [ Math 19 ]$$

n in this case indicates the longitudinal mode emitted by the laser: (for example, n=0 corresponds to mode ν₀, n=1 corresponds to mode ν₀+Δν, etc.).

By way of an example, in the case of a laser having a free spectral interval (FSI), with FSI=c/2L, where L is the length of the cavity, of 250 MHz, at 1,064 nm, and for an angle of incidence of 67.7°, the angular dispersion between each mode is 1.075 μrad.

Thus, if the laser emits several longitudinal modes, the diffracted total electric field is expressed as:

$$\vec{E} = {E}_{0} ( x , y , t ) ( {\sum }_{0}^{N} \frac{1}{\sqrt{N}} {e}^{j [ ( {ω}_{0} + n Δω ) t - \vec{{k}_{n}} \cdot \vec{r} + {ϕ}_{n} ]} + c c ) \vec{{e}_{1}} \qquad [ Math 20 ]$$

Thus, for an incident field on the grating formed by N optical frequencies vₙ=v₀+n·Δv, since each optical frequency propagates in a different direction, a drop in the degree of coherence of the optical field is observed.

More specifically,the wave vector associated with each spectral component is provided by:

$$\vec{{k}_{n}} = ( \begin{matrix}{k}_{n x} \\ {k}_{n z}\end{matrix} ) = ( \begin{matrix}\frac{2 π}{{λ}_{0}} \cdot sin ( {θ}_{n} ) \\ \frac{2 π}{{λ}_{0}} \cdot cos ( {θ}_{n} )\end{matrix} ) ∼ ( \begin{matrix}\frac{2 π}{{λ}_{0}} . [ sin ( {θ}_{d} ) + \frac{n \cdot Δ v \cdot c}{2 {v}_{0}^{2} \cdot a} ] \\ \frac{2 π}{{λ}_{0}} . [ cos ( {θ}_{d} ) - \frac{n \cdot Δ v \cdot c}{2 {v}_{0}^{2} . a} tan ( {θ}_{d} ) ]\end{matrix} ) \qquad [ Math 21 ]$$

The presence of a multitude of wave vectors at the output of the grating is equivalent to an angular distribution of the spectral components of the laser. The degree of spatial coherence of the source is thus reduced.

If the diffracted electric field is incident on the DOE, then there will be light intensity distribution in the Fourier plane of the lens according to the following law:

$$I ( u , v ) = {\sum }_{0}^{N} \frac{1}{N} {I}_{Out} ( u - n \cdot F \cdot tan {θ}_{n} , v ) \qquad [ Math 22 ]$$

The intensity pattern in the Fourier plane therefore corresponds to a sum of diffraction patterns spatially offset in the direction u, with each spectral component being made up of the same deterministic portion and of the same random portion. Each diffraction pattern corresponding to a longitudinal mode is offset by the distance F·tan θₙ of the diffraction patterns corresponding to the longitudinal modes that are adjacent thereto. If the N spectral lines of the laser meet the condition

$$. tan ( {Δθ}_{d} ) > \frac{λ}{D} ,$$

then the intensity profile will be made up of a sum of noisy profiles that are not correlated with one another. The contrast of the speckle that is observed thus will be reduced by a factor of \sqrt{N}.

It should be noted that in the example of FIG. 5A, the shaping module comprises a single grating.

FIG. 5B shows a simplified diagram illustrating a spatial shaping module with a first grating 511 and a second grating 512, for spatially shaping pulses in a system according to the present description. In this example, two mirrors 513, 514 are configured to route the beams with an angle of incidence on each of the gratings that maximizes their respective effectiveness. The use of two gratings instead of only one (FIG. 5A) allows the angular dispersion to be doubled.

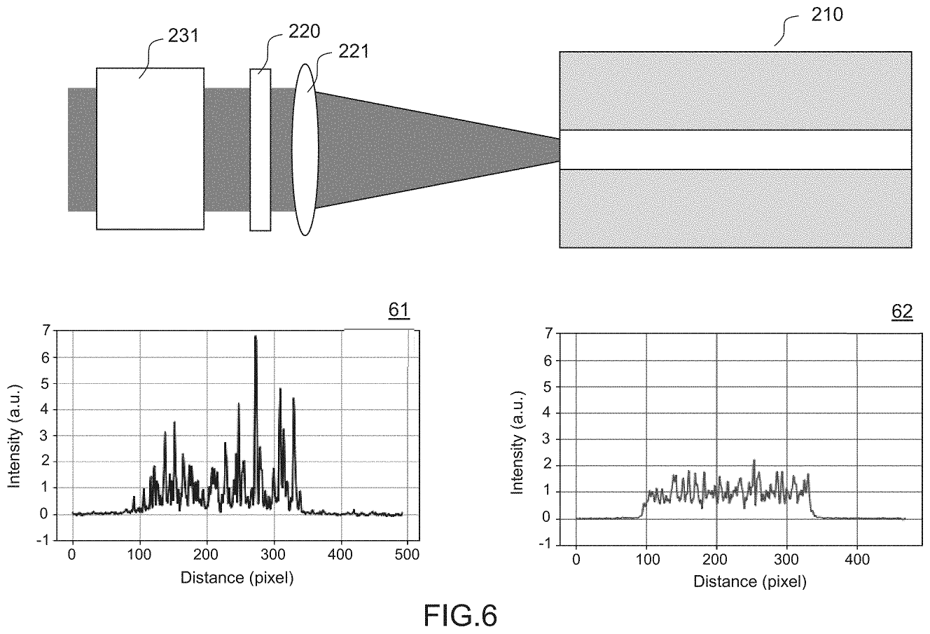

FIG. 6 shows a simplified diagram illustrating elements of a system for generating high peak power laser pulses according to the present description with a spatial shaping module 231 comprising one or more gratings, as described, for example, with reference to FIG. 5A or to FIG. 5B.

The diagram 61 (FIG. 6) illustrates a “top hat” intensity profile at the input of the multimode fiber 210, without a shaping module. The speckle contrast is equal to 0.72 in this example.

The diagram 62 (FIG. 6) illustrates a “top hat” intensity profile at the input of the multimode fiber 210, with one shaping module to one grating, as illustrated, for example, in FIG. 5A. The grating in this example comprises a pitch of 575 nm and is optimized for a wavelength of 1,064 nm with a LITTROW angle of incidence of 67.7°. The light source that is used in this example is a laser emitting at 1,064 nm and having several longitudinal modes (FSI=250 MHz). The spatial shaping module thus produced allows the initial contrast to be reduced by a factor of 2.5.

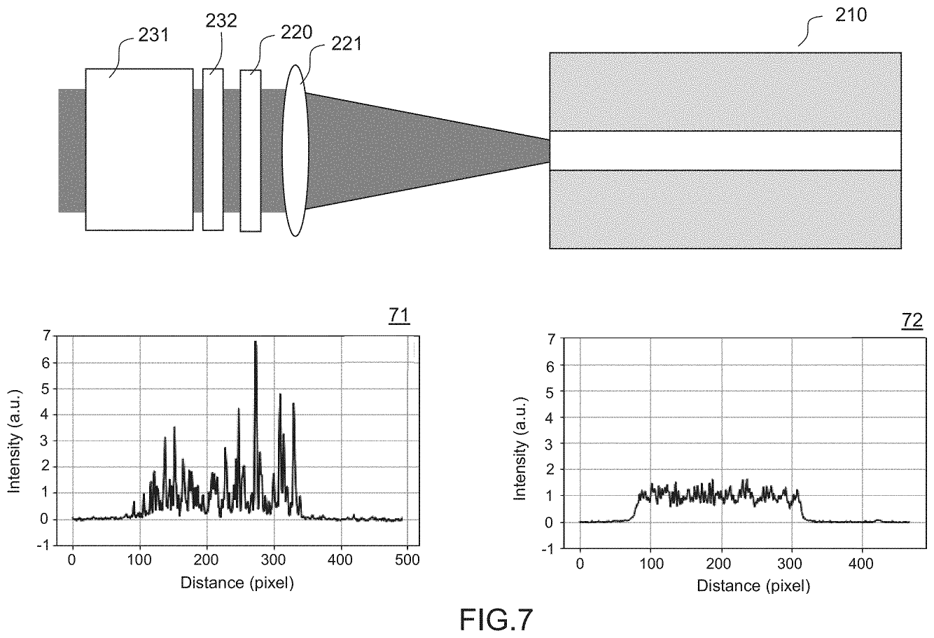

Of course, the shaping module can equally comprise a polarization scrambler 232 and a grating device 231, as described in FIG. 7.

In this case, the grating device 231 must be upstream of the depolarizer 232. Indeed, the diffraction can be affected h the depolarization of the incident beam. As can be seen in diagrams 71, 72, the effect of the modules 231, 232 accumulates in such a way that the contrast of the speckle transitions from 0.72 (diagram 71, without a shaping module) to 0.2 (diagram 72).

Although described through several embodiments, the methods and the devices according to the present description include various alternative embodiments, modifications and improvements that will become apparent to a person skilled in the art, with it being understood that these various alternative embodiments, modifications and improvements form part of the scope of the invention as defined by the following claims.

### REFERENCES

Ref. 1: U.S. Pat. No. 6,002,102

Ref. 2: EP 1528645

Ref. 3: U.S. Pat. No. 6,818,854

Ref. 4: WO 2019/233899

Ref. 5: W0 2019/233900

Ref. 6: U.S. Pat. No. 9,599,834

1. A system for generating high peak power laser pulses comprising:
a light source for emitting initial nanosecond laser pulses;
a fiber-based device for conveying laser pulses, comprising at least one first muilimode fiber with a single core;
a diffractive optical element and an optical system both arranged upstream of the fiber-based device, and configured to generate, from each of said initial laser pulses, a laser pulse at the input of the fiber-based device, wherein the spatial intensity distribution of each of said laser pulses on an input face of said first multimode fiber comprises a low spatial frequency “top hat” type component summed with a high spatial frequency component resulting from speckle type interference;
a spatial shaping module, arranged upstream of the fiber-based device, configured to transform a first electric field into a second electric field formed by a sum of N components that are at least partially spatially incoherent with one another, N≥2, such that the contrast of the high spatial frequency component resulting from speckle type interference is limited compared to an initial contrast defined without said spatial shaping module.

2. The laser pulse generation system as claimed in claim 1, wherein said spatial shaping module is arranged upstream of said optical system.

3. The laser pulse generation system as claimed in claim 1, wherein said spatial shaping module comprises a polarization scrambler, configured to transform a first electric field into a second electric field formed by a sum of two components along two orthogonal axes, with the two components having a variable phase shift along a given axis.

4. The laser pulse generation system as claimed in claim 3, wherein:
said variable phase shift along said axis is periodic, resulting in a periodic variation of a polarization state of the electric field at the output of the polarization scrambler; and
the polarization scrambler is arranged such that a spatial intensity distribution of said first electric field comprises, along said axis, a dimension that is greater than a variation period of the polarization state.

5. The laser pulse generation system as claimed in claim 1, wherein:
the source is a longitudinal multimode source; and
said spatial shaping module comprises at least one first diffraction grating, configured to transform a first electric field into a second electric field formed by a sum of N components, N≥2, wherein said N components are characterized by non-collinear wave vectors.

6. The laser pulse generation system as claimed in claim 5, wherein N is comprised between 2 and 10.

7. The laser pulse generation system as claimed in claim 5, wherein said spatial shaping module comprises at least one second grating arranged downstream said first grating.

8. The laser pulse generation system as claimed in claim 5, wherein said spatial shaping module further comprises a polarization scrambler, with said at least one first grating being arranged upstream the polarization scrambler.

9. A method for generating high peak power laser pulses comprising:
emitting initial nanosecond laser pulses by means of a light source;
generating, by means of a diffractive optical element and of an optical system, from each of said initial laser pulses, a laser pulse, wherein the spatial intensity distribution of each of said laser pulses in a Fourier plane of the optical system comprises a low spatial frequency “top hat” type component summed with a high spatial frequency component resulting from speckle type interference;
conveying said laser pulses by means of a fiber-based device comprising a multimode fiber with a single core, wherein an input face of the multimode fiber is substantially coincident with said Fourier plane of the optical system;
spatially shaping said initial laser pulses by means of a spatial shaping module, arranged upstream of the fiber-based device, and configured to transform a first electric field into a second electric field formed by a sum of a plurality of N components, N≥2, wherein said N components are at least partially spatially incoherent with one another, such that the contrast of the spatial high frequency component resulting from the speckle type interference on the input face of said first multimode fiber is limited compared to an initial contrast defined without said spatial shaping module.
